(19) United States
(12) Patent Application Publication
(10) Pub. No.: US 2024/0158035 A1
(43) Pub. Date: May 16, 2024

(54) SADDLE FOR BICYCLES WITH A SIMPLIFIED CONSTRUCTION AND RELATED MANUFACTURING METHOD

(71) Applicant: SELLE ITALIA S.R.L., Asolo (Treviso) (IT)

(72) Inventors: Riccardo BIGOLIN, Asolo (Treviso) (IT); Andrea BUZZAVO, Asolo (Treviso) (IT)

(21) Appl. No.: 18/477,800

(22) Filed: Sep. 29, 2023

(30) Foreign Application Priority Data
Nov. 11, 2022 (IT) 102022000023310

(51) Int. Cl. B62J 1/08; B62J 1/18

(52) U.S. Cl. CPC B62J 1/08; B62J 1/18

(57) ABSTRACT

A saddle for bicycles is provided which has a frame having a peripheral structure, configured to be fixed to a corresponding upright of a bicycle frame, a body overlapping the frame along a vertical direction, substantially perpendicular to the bod, and anchored to the frame by shape coupling elements, and a padding having a cushion overlapping the body along the vertical direction, made of an elastic polymeric material. The shape coupling elements include a plurality of pegs and relative fixing holes. The pegs are in a single piece with the cushion of the padding and facing toward the body. The pegs are embedded in the fixing holes provided on the body.

### CROSS-REFERENCE TO RELATED APPLICATION

This application claims priority to Italian Patent Application No. 102022000023310 filed Nov. 11, 2022, the entire contents of which is hereby incorporated in its entirety by reference.

### FIELD OF THE INVENTION

The present invention is directed to a saddle for bicycles with simplified construction and the related manufacturing method.

### PRIOR ART

Known within the bicycle sector are saddles that are required to be inexpensive to make and assemble and that are required, at the same time, to ensure the necessary riding comfort.

Customarily, prior art saddles are made in at least three pieces that include a support frame which is typically tubular and configured to be in turn attached to a bicycle frame, a body, overlapping said frame, and a padding, typically made of foam material, which in turn overlaps and is glued to the body and supported thereby.

Such solutions have some drawbacks and disadvantages in terms of implementation/assembly.

For example, the step of molding the padding and applying it to the body is critical: such application must in fact be on the one hand precise and on the other hand must not give rise, over time, to slipping of the padding which is normally glued to the body. Such possible slippages may compromise the comfort of the saddle insofar as they affect the shock absorption capabilities and also the freedom of compression/flexing of the padding itself.

The use of gluing involves problems in relation to the application of the glue and associated therewith, such as, considering that the saddle undergoes continuous deformation cycles and is subject to weathering, the disposal and sealing thereof over time.

Furthermore, gluing signifies time for the adhesive to spread and waiting time for it to dry/seal between pieces that are to be mutually bonded.

### SUMMARY OF THE INVENTION

The need to overcome the drawbacks and limitations mentioned with reference to the prior art is therefore felt.

This need is satisfied by a bicycle saddle and a method for manufacturing a bicycle saddle as described and claimed herein.

### BRIEF DESCRIPTION OF THE DRAWINGS

Further features and advantages of the present invention will become more apparent from the following detailed description of preferred, non-limiting embodiments thereof, wherein:

FIG. 1 shows a perspective view, in an exploded configuration, of a bicycle saddle according to one embodiment of the present invention;

FIG. 2 shows a perspective view from above and from below of the bicycle saddle of FIG. 1, in an assembled configuration;

FIG. 3 shows a lateral view of the bicycle saddle of FIG. 1, in an assembled configuration;

FIG. 4 shows a plan view from below of the bicycle saddle of FIG. 1, in an assembled configuration;

FIG. 5 shows, enlarged, the detail V indicated in FIG. 4;

FIG. 6 shows a cross-sectional view of the bicycle saddle in FIG. 1, along the cross-sectional plane VI-VI shown in FIG. 4;

FIG. 7 shows, enlarged, the detail VII indicated in FIG. 6;

FIG. 8 shows a plan view of the base of the bicycle saddle according to a further embodiment of the present invention;

FIG. 9 shows a sectional view of the saddle of FIG. 8, along the section plane IX-IX of FIG. 8;

FIG. 10 shows, enlarged, the detail X indicated in FIG. 9;

FIG. 11 shows, enlarged, the detail XI indicated in FIG. 8;

FIG. 12 shows, enlarged, the detail XII indicated in FIG. 9; and

FIGS. 13-15 show views of details of shape coupling means according to further embodiments of the present invention.

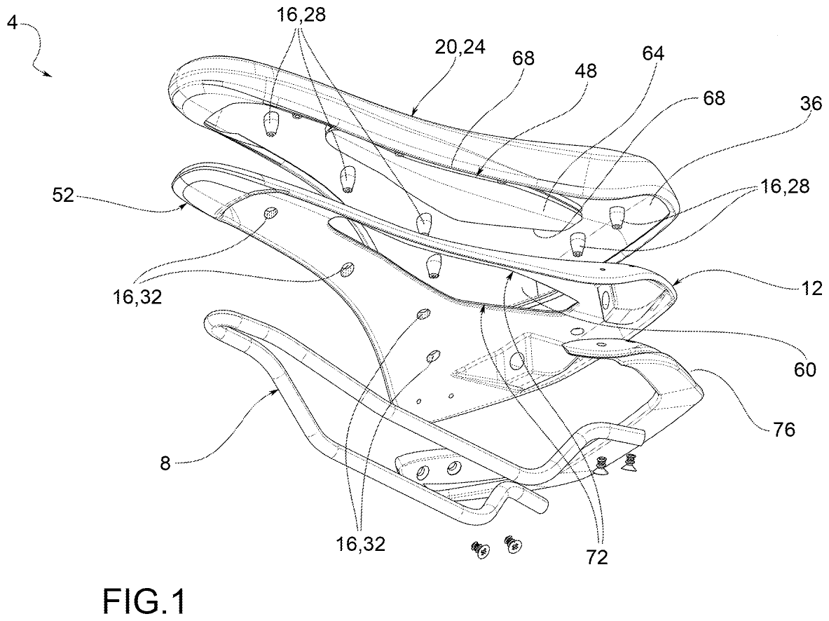

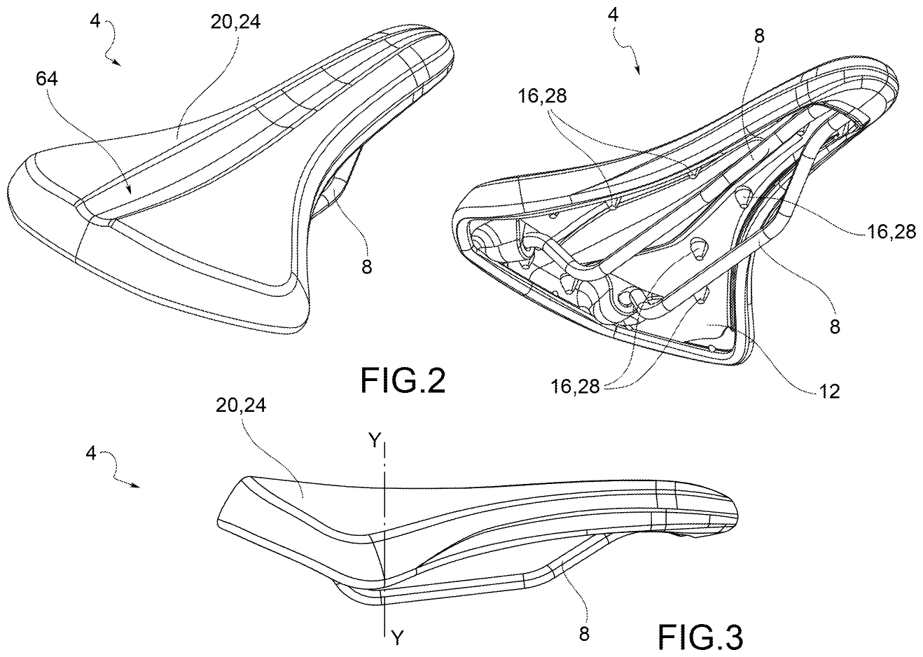

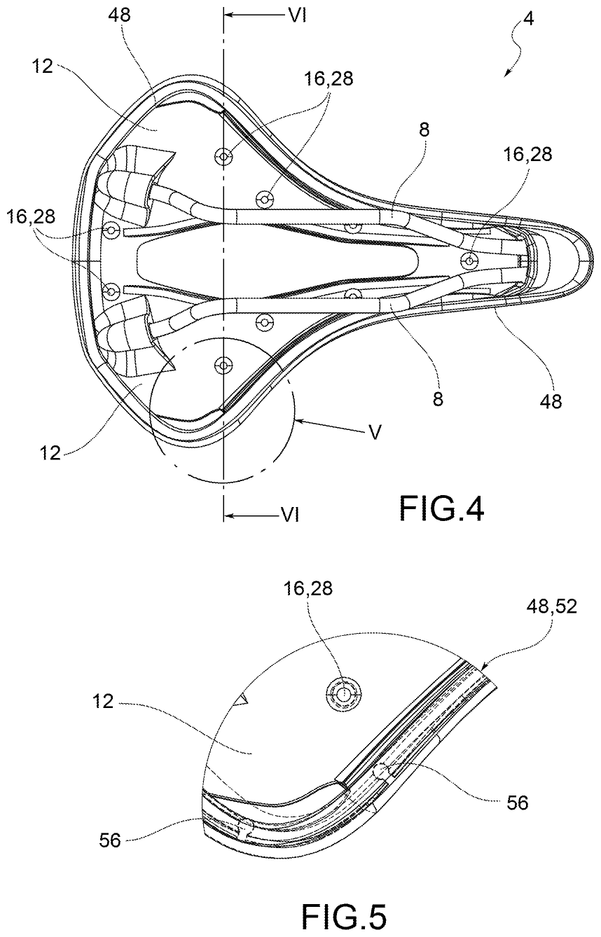

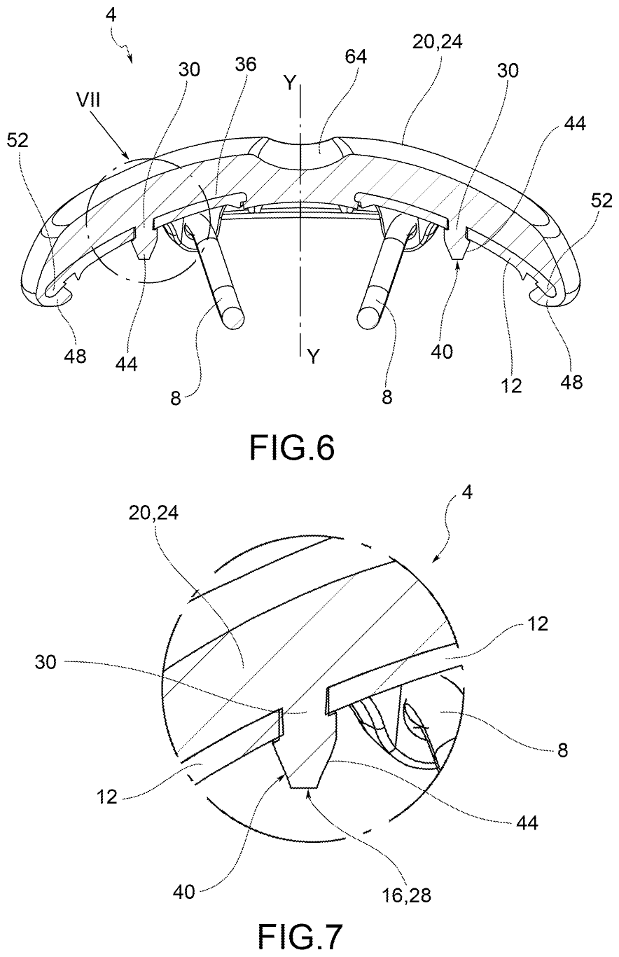

Elements or parts of elements common to the embodiments described hereinafter will be indicated with the same numerical references.

### DETAILED DESCRIPTION

With reference to the figures, an overall view of a bicycle saddle is indicated collectively with the numeral 4.

The saddle 4 comprises a frame 8 having a peripheral structure, configured to be fixed, in a known way, to a corresponding upright of a bicycle frame (not show). The frame 8 of the saddle 4 is typically a hollow tubular element and is manufactured, in a known way, from a metal or polymeric material.

The saddle 4 comprises, furthermore, a body 12 that overlaps said frame 8, along a vertical direction Y-Y, substantially perpendicular to said body 12, and anchored thereto by shape coupling means 16.

The saddle 4 comprises, furthermore, a padding 20 comprising a cushion 24 overlapping said body 12 along said vertical direction Y-Y, made of an elastic polymeric material. Preferably said padding is made of EVA (ethylene vinyl acetate).

Advantageously, said shape coupling means 16 comprise a plurality of pegs 28 and relative fixing holes 32, wherein said pegs 28 are in a single piece with the cushion 24 of the padding 20 and facing toward the body 12. Furthermore, said pegs 28 are embedded with said fixing holes 32, provided on the body 12.

Preferably, the fixing holes 32 are through the body 12.

According to one possible embodiment, said pegs 28 have a base 30, in a single piece with an inner wall 36 of the padding 20, facing the body 12, and a head 40, cantilevered with respect to the base 30.

According to one possible embodiment, said base 30 makes an undercut with the fixing holes 32 of the body 12, along the vertical direction Y-Y.

According to one possible embodiment, the head 40 has a front flare 44 configured to facilitate the insertion of the head 40 through the fixing hole 32.

According to one possible embodiment, an outer peripheral edge 48 of the padding 20 makes an undercut with an outer peripheral wall 52 of the body 12, along the vertical direction Y-Y.

According to one possible embodiment, at least one male-female coupling and/or an engagement 56 is included between the outer peripheral edge 48 of the padding 20 and the outer peripheral wall 52 of the body 12.

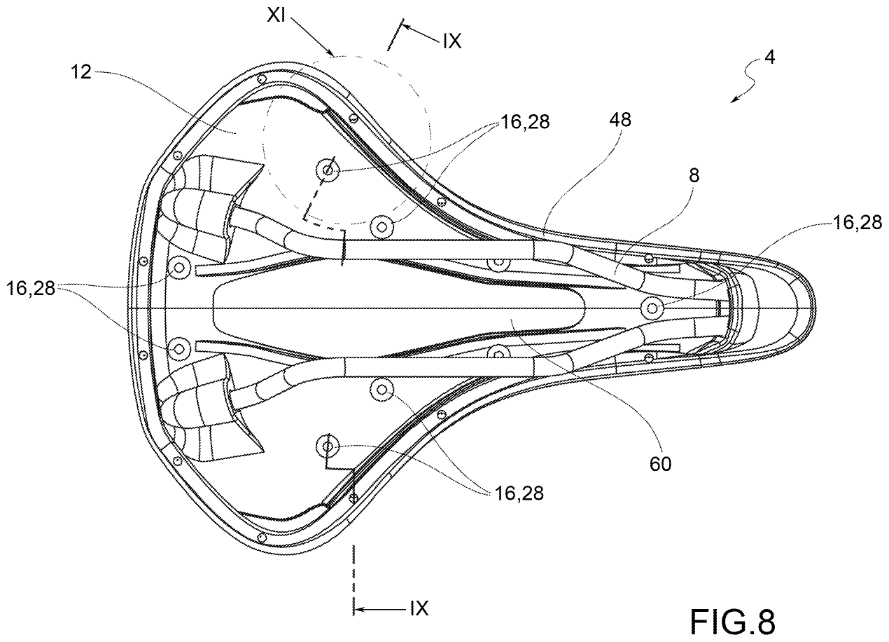

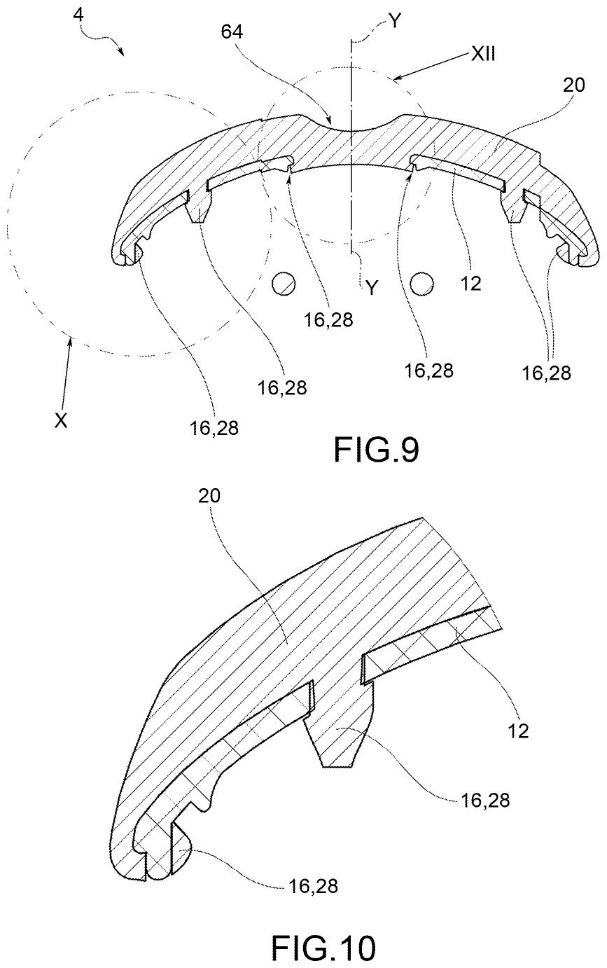

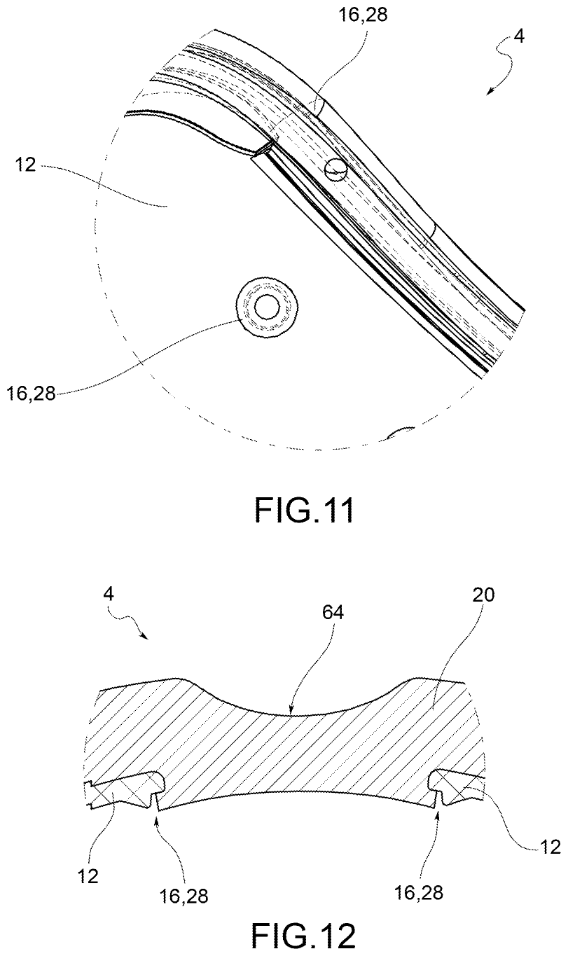

According to one possible embodiment (FIGS. 8-12), said shape coupling means 16 comprise pegs 28 arranged between the outer peripheral edge 48 of the padding 20 and the outer peripheral wall 52 of the body 12.

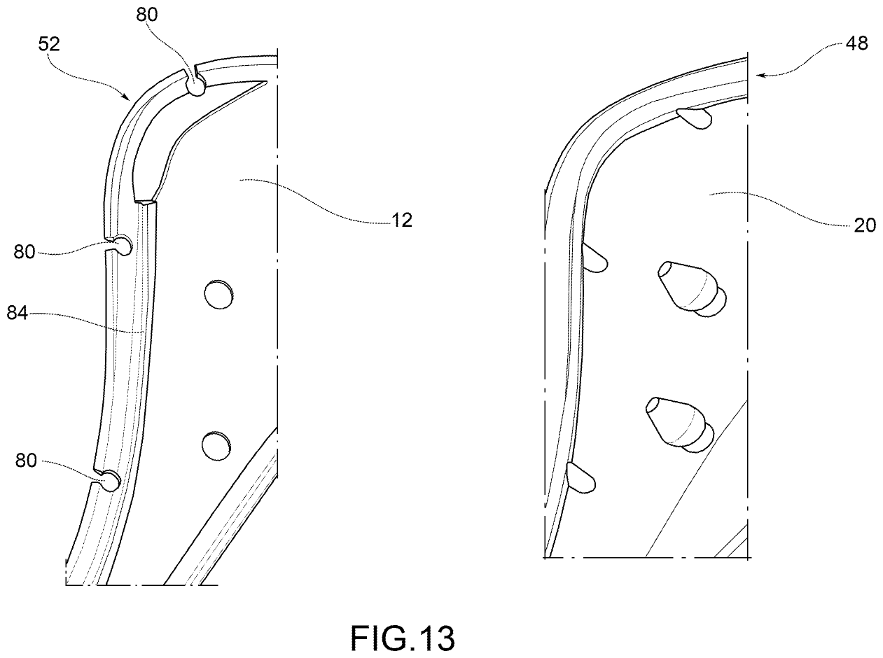

It is also possible to include slits 80 and ribs 84 at the outer peripheral wall 52 of the body 12, which engage with corresponding pegs 28 on the padding 20 (FIG. 13). In particular, the slits 80 facilitate the insertion of the pegs 28 and the ribs 84 make a further undercut coupling with the padding 20.

According to one possible embodiment, at least one connection by welding is included between the outer peripheral edge 48 of the padding 20 and the outer peripheral wall 52 of the body 12.

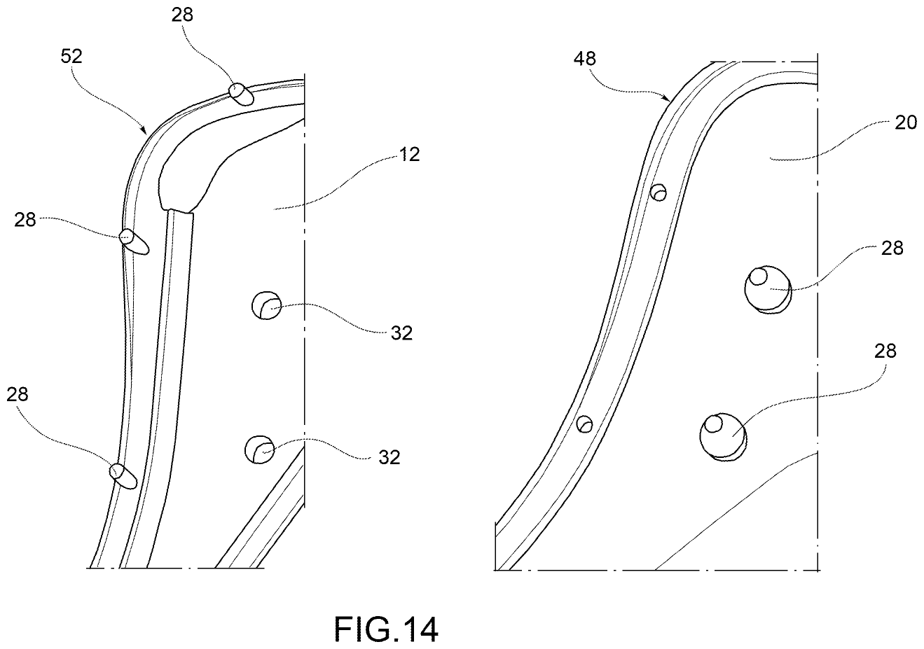

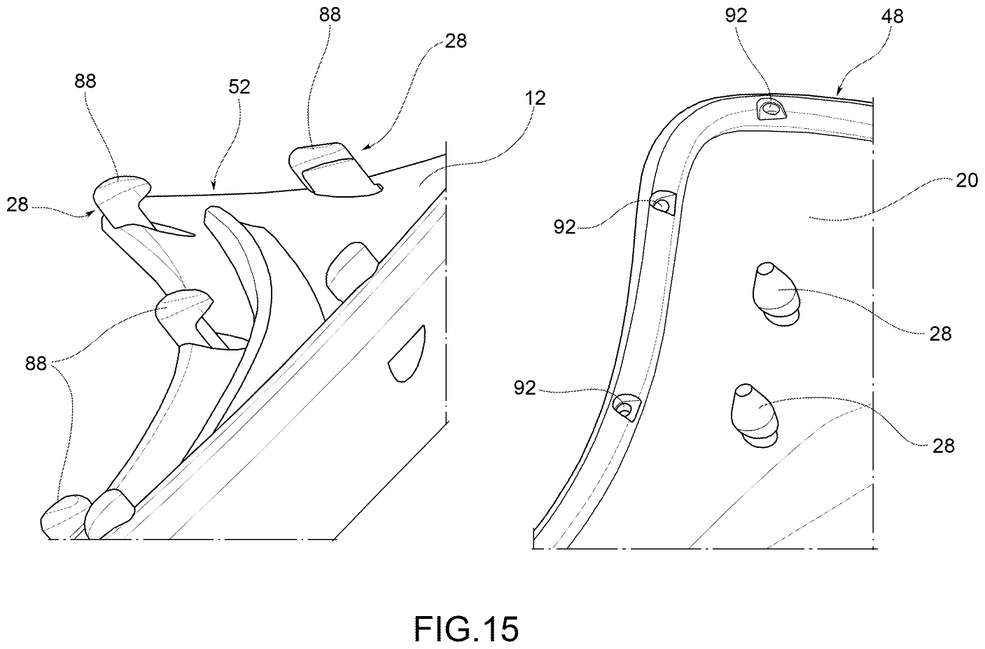

According to one possible embodiment (FIGS. 14-15), the pegs 28 are also associated with the body 12, at the outer peripheral wall 52 of the body 12, and are engaged in fixing holes 32 formed on the outer peripheral edge 48 of the padding 20.

According to one possible embodiment (FIG. 15), the pegs 28 on the body have a hook head 88 which engages in counter-shaped seats 92, configured to engage with said hook head 88.

According to one possible embodiment, the body 12 comprises a central hole 60 and the padding 20 includes a corresponding lowered central seat 64 counter-shaped to the central hole 60, wherein at the respective perimeters of the central hole 60 and the lowered central seat 64, the padding 20 includes an inner peripheral edge 68 which makes an undercut with an inner peripheral wall 72 of the body 12, along the vertical direction Y-Y.

According to one possible embodiment, at least one male-female coupling and/or at least one connection by welding are included at said respective perimeters of the central hole 60 and the lowered central seat 64.

According to one possible embodiment (FIGS. 8-12), said shape coupling means 16 comprise pegs 28 arranged at said respective perimeters of the central hole 60 and the lowered central seat 64.

Preferably, said lowered central seat 64 is a hole through the padding 20.

A handhold 76 may also be associated with the body 12.

The method for manufacturing and assembling a bicycle saddle according to the present invention will now be described.

In particular, the method proceeds with the step of arranging a frame 8 having a perimeter structure, configured to be fixed to a corresponding upright of a bicycle frame, arranging a body 12 to overlap said frame 8, along the vertical direction Y-Y, substantially perpendicular to said body 12, said body 12 being provided with fixing holes 32.

Additionally, the step is performed of molding a padding 20 in an elastic polymeric material, said padding 20 comprising, in a single piece, a cushion 24 and a plurality of pegs 28.

The molding of the padding 20 presents some peculiarities.

In particular, after the step of extracting the padding 20 from the mold, a geometric increase in the volume of the padding 20 of at least 30% and a subsequent shrinkage of at least 20% are expected.

In particular, the first step of increasing the volume is due to the fact that the polymeric material, once it has been extracted from the mold, tends to expand.

Subsequently, due to cooling, a reduction in volume occurs.

The manufacturing method therefore comprises the step of engaging, according to a shape coupling, the pegs 28 in said fixing holes 32 during said cooling.

Such coupling within the fixing holes 32 is facilitated by the presence of the front flare 44.

The diameter of the fixing holes 32 is less than the thickness of the head 40: in this way, undercuts are obtained with the fixing holes 32, along the vertical direction, in such a way as to make the padding 20 and the body 12 integral.

Finally the frame 8 is associated with the assembly comprising the body 12 and the padding 20.

As may be appreciated from what has been described, the present invention overcomes the drawbacks of the prior art.

In particular, the present invention makes it possible to obtain a saddle that is economical to manufacture as the steps of gluing the padding to the body that occur in the solutions of the prior art are eliminated.

Therefore, the timescales and costs of the saddle molding and assembly operations are reduced.

Moreover, the risks that occur with use in saddles of the prior art of the upholstery slipping in relation to the padding are avoided.

The saddle, thus manufactured, is also eco-friendly insofar as it does make use of glues.

Furthermore, the saddle, thus manufactured and assembled, is safe and reliable over time insofar as the shape couplings between the padding and the body ensure a complete and long-lasting assembly between the various parts.

In this way normal operating of the padding is also achieved, thereby ensuring consistent riding comfort also after prolonged use.

A person skilled in the art, for the purpose of satisfying contingent and specific needs, may make numerous modifications and variations to the solutions described above.

The scope of protection of the invention is defined by the following claims.

What is claimed is:

1. A saddle for bicycles comprising:
a frame having a peripheral structure, configured to be fixed to a corresponding upright of a bicycle frame,
a body overlapping said frame, along a vertical direction, substantially perpendicular to said body, and anchored to the frame by shape coupling means,
a padding comprising a cushion overlapping said body along said vertical direction, made of an elastic polymeric material,
wherein said shape coupling means comprise a plurality of pegs and relative fixing holes, wherein said pegs are in a single piece with the cushion of the padding and facing toward the body, and wherein said pegs are embedded in said fixing holes, provided on the body.

2. The saddle for bicycles of claim 1, wherein said fixing holes are through the body.

3. The saddle for bicycles of claim 1, wherein said pegs have a base in a single piece with an inner wall of the padding, facing the body, and a head cantilevered with respect to the base.

4. The saddle for bicycles of claim 3, wherein said base is configured to make an undercut with the fixing holes of the body, along the vertical direction.

5. The saddle for bicycles of claim 3, wherein the head has a front flare configured to facilitate an insertion of the head through the fixing holes.

6. The saddle for bicycles of claim 1, wherein an outer peripheral edge of the padding makes an undercut with an outer peripheral wall of the body, along the vertical direction.

7. The saddle for bicycles of claim 6, wherein at least one male-female coupling is included between the outer peripheral edge of the padding and the outer peripheral wall of the body.

8. The saddle for bicycles of claim 6, wherein said shape coupling means comprise pegs arranged between the outer peripheral edge of the padding and the outer peripheral wall of the body.

9. The saddle for bicycles of claim 8, wherein said shape coupling means comprise slits and ribs at the outer peripheral wall of the body which engage with corresponding pegs on the padding.

10. The saddle for bicycles of claim 9, wherein said slits are configured to facilitate an insertion of the pegs and the ribs are configured to make an undercut coupling with the padding.

11. The saddle for bicycles of claim 8, wherein the pegs are also associated with the body, at the outer peripheral wall of the body and are engaged in fixing holes formed on the outer peripheral edge of the padding.

12. The saddle for bicycles of claim 11, wherein the pegs on the body have a hook head which engages in counter-shaped seats, configured to engage with said hook head.

13. The saddle for bicycles of claim 6, wherein at least one connection by welding is included between the outer peripheral edge of the padding and the outer peripheral wall of the body.

14. The saddle for bicycles of claim 1, wherein the body comprises a central hole and the padding comprises a corresponding lowered central seat counter-shaped to the central hole, wherein at respective perimeters of the central hole and the lowered central seat, the padding includes an inner peripheral edge that makes an undercut with an inner peripheral wall of the body, along the vertical direction.

15. The saddle for bicycles of claim 14, wherein at least one male-female coupling and/or an engagement and/or at least one connection by welding are included at said respective perimeters of the central hole and the lowered central seat.

16. The saddle for bicycles of claim 14, wherein said shape coupling means comprise pegs arranged at said respective perimeters of the central hole and the lowered central seat.

17. The saddle for bicycles of claim 14, wherein said lowered central seat is a hole through the padding.

18. The saddle for bicycles according of claim 1, wherein the padding is made of ethylene vinyl acetate (“EVA”).

19. A method for making a saddle for bicycles, the method comprising:
providing a frame having a peripheral structure, configured to be fixed to a corresponding upright of a bicycle frame,
providing a body to overlap said frame along a vertical direction, substantially perpendicular to said body, said body being provided with fixing holes,
molding in a mold a padding in an elastic polymeric material, said padding comprising, in a single piece, a cushion and a plurality of pegs,
extracting the padding from the mold, and waiting for a geometric increase in a volume of the padding of at least 30% and a subsequent shrinkage of at least 20%,
engaging, according to a shape coupling, the pegs in said fixing holes, a diameter of the fixing holes being less than a thickness of a head of the pegs, so as to obtain undercuts with the fixing holes along said vertical direction and to make the padding and the body integral, and
associating the frame with an assembly comprising the body and the padding.
